(19) United States
(12) Patent Application Publication
(10) Pub. No.: US 2014/0183132 A1
(43) Pub. Date: Jul. 3, 2014

(54) SEPARATION MEMBRANE CLEANING SYSTEM AND SEPARATION MEMBRANE CLEANING METHOD USING THE SAME

(71) Applicant: CHEIL INDUSTRIES INC., Gumi-si (KR)

(72) Inventors: Pyung Kyu PARK, Uiwang-si (KR); Tai Kwang YOON, Uiwang-si (KR); Chang Min PARK, Uiwang-si (KR); Byung Kook HWANG, Uiwang-si (KR); Jae Seok JO, Uiwang-si (KR); Sung Ho HONG, Uiwang-si (KR); Gyu Hong MIN, Uiwang-si (KR); Jong Sang PARK, Uiwang-si (KR)

(73) Assignee: CHEIL INDUSTRIES INC., Gumi-si (KR)

(21) Appl. No.: 14/142,514

(22) Filed: Dec. 27, 2013

(30) Foreign Application Priority Data
Dec. 27, 2012 (KR) 10-2012-0155611

(51) Int. Cl. B01D 65/02

(52) U.S. Cl. CPC B01D 65/02
USPC 210/636; 210/321.69; 210/108

(57) ABSTRACT

A separation membrane cleaning system and a separation membrane cleaning method. A separation membrane cleaning system includes: a membrane filtration bath; a treated water storage bath configured to store treated water produced by the membrane filtration bath and discharge the treated water during reverse cleaning or chemical cleaning; a chemical storage bath configured to supply a chemical; a first pipe fluidically communicated between the membrane filtration bath and the treated water storage bath to transport the treated water produced by the membrane filtration bath to the treated water storage bath, and a fourth pipe fluidically communicated with the first pipe to transport the chemical to the membrane filtration bath; a second pipe to transport the treated water from the treated water storage bath; and a third pipe fluidically communicated with the fourth pipe to transport the chemical from the chemical storage bath.

### CROSS-REFERENCE TO RELATED APPLICATION

This application claims priority to and the benefit of Korean Patent Application No. 10-2012-0155611, filed on Dec. 27, 2012 in the Korean Intellectual Property Office, the entire disclosure of which is incorporated herein by reference.

### BACKGROUND

1. Field

Aspects of embodiments of the present invention relate to a separation membrane cleaning system and a separation membrane cleaning method using the same.

2. Description of the Related Art

In management of a membrane filtration process for water treatment, membrane fouling caused by underwater contaminants deteriorates filtration efficiency to decrease yield rate, or requires more energy for the same production. Accordingly, physical cleaning methods, such as reverse washing and bubbling, and chemical cleaning methods using chemicals are used to retard, alleviate, or remove membrane fouling. Cleaning with chemicals may be performed using a chemical solution at high temperature. In equipment including a pressurizing type membrane module fitted to a housing and provided with a filtration loop, instead of a dipping type module in which a filtration module is directly dipped in liquid (raw water) to be filtered, chemical cleaning of membranes may be performed without separating the membranes from the equipment. This type of chemical cleaning is called in-place cleaning and allows a chemical liquid to be circulated simply in a recirculation loop. However, this type of filtration equipment can neither be coupled to the housing nor to the recirculation loop.

One method of cleaning such filtration equipment having dipping type membranes using chemicals includes ex-situ chemical cleaning. Ex-situ chemical cleaning may be simply performed by sequentially separating a filtration module from a chemical cleaning tank and cleaning the filtration module in a specially prepared device using a chemical. However, ex-situ chemical cleaning cannot be easily automated. As another example, there is a technology of replacing liquid in a treatment tank with a chemical solution and allowing a cleaning solution to pass through pores of membranes to clean the cleaning equipment having the dipping type membranes with the chemical solution. However, this technology requires a large amount of chemicals, and thus has low economic feasibility.

Typically, upon cleaning of the filtration equipment having dipping type membranes with a chemical, the separation membranes are dipped in a chemical cleaning liquid or subjected to bubbling while stirring the chemical. In this method, however, the membrane pores do not effectively contact the chemical. In addition, although cleaning efficiency is generally identified by measuring the degree of water penetration after completion of chemical cleaning, cleaning can be unnecessarily performed even when contaminants are completely removed from the membranes to a desired degree before a predetermined cleaning time. Moreover, when bubbling is consistently or continually performed during cleaning with chemicals, unnecessary energy consumption can occur in the course of cleaning.

### SUMMARY

According to an aspect of embodiments of the present invention, in a separation membrane cleaning system and a separation membrane cleaning method, a contact area of a chemical with membrane pores is increased by circulating a chemical cleaning liquid in a same direction as a filtering direction through membranes, which enables rapid or immediate control of cleaning by monitoring a degree of chemical cleaning based on a circulation flow rate and a pressure during chemical cleaning, and can optimize or improve chemical cleaning time, chemical usage, life span of separation membranes, and energy consumption for cleaning.

According to one or more embodiments of the present invention, a separation membrane cleaning system includes: a membrane filtration bath; a treated water storage bath configured to store treated water produced by the membrane filtration bath and discharge the treated water during reverse cleaning or chemical cleaning; a chemical storage bath configured to supply a chemical during chemical cleaning of the membrane filtration bath; a first pipe fluidically communicated between the membrane filtration bath and the treated water storage bath to transport the treated water produced by the membrane filtration bath to the treated water storage bath, and a fourth pipe fluidically communicated with the first pipe to transport the chemical to the membrane filtration bath; a second pipe to transport the treated water from the treated water storage bath during reverse cleaning or chemical cleaning; and a third pipe fluidically communicated with the fourth pipe to transport the chemical from the chemical storage bath and allow a chemical cleaning liquid formed by mixing the chemical and the treated water to be introduced into the membrane filtration bath.

The second pipe may be connected to the first pipe and fluidically communicated therewith.

The separation membrane cleaning system may further include a produced water pump on the first pipe.

The separation membrane cleaning system may further include a controller configured to control production of the treated water in the membrane filtration bath, supply of the chemical in the chemical storage bath, and discharge of the treated water from the treated water storage bath.

The separation membrane cleaning system may further include: a fifth pipe branched form the first pipe and fluidically communicated with the fourth pipe; and a circulation pump on the fifth pipe.

At least one of the first to fifth pipes may be provided with a cut-off valve to be opened or closed by the controller.

The separation membrane cleaning system may further include a pressure gauge provided to the first pipe, and information of the pressure gauge may be transmitted to the controller.

The separation membrane cleaning system may further include a mass flow meter provided to the fourth pipe, and information of the mass flow meter may be transmitted to the controller.

The treated water produced by the membrane filtration bath may be discharged outside or fed to the treated water storage bath through the first pipe during filtration, and the chemical may be injected into the fourth pipe through the third pipe while the treated water is fed to the membrane filtration bath through the second pipe and the fourth pipe during chemical cleaning.

The chemical cleaning liquid may be circulated through the first pipe and the fourth pipe, and a water penetration degree of membranes and a chemical cleaning efficiency may be calculated by measuring a circulation flow rate and a pressure.

The chemical may be circulated through the first pipe, the fifth pipe, and the fourth pipe, and a water penetration degree of membranes and a chemical cleaning efficiency may be calculated by measuring a circulation flow rate and a pressure.

According to another embodiment of the present invention, a separation membrane cleaning method using the separation membrane cleaning system described above includes: storing some of the treated water produced by the membrane filtration bath in the treated water storage bath, and discharging a remainder of the treated water outside; discharging the treated water stored in the treated water storage bath through the second pipe while discharging the chemical stored in the chemical storage bath through the third pipe, the second pipe and the third pipe being fluidically communicated with the fourth pipe such that the treated water and the chemical are mixed to produce the chemical cleaning liquid; introducing the chemical cleaning liquid into the membrane filtration bath; filtering the chemical cleaning liquid through membranes in the membrane filtration bath; and circulating the filtered chemical cleaning liquid.

The filtered chemical cleaning liquid may be circulated by a produced water pump.

The produced water pump may be disposed on the first pipe.

The filtered chemical cleaning liquid may be circulated by a circulation pump.

The circulation pump may be disposed on a fifth pipe branched from the first pipe and fluidically communicated with the fourth pipe.

The method may further include: measuring a circulation flow rate and a pressure while monitoring a chemical cleaning efficiency to control chemical cleaning.

According to aspects of embodiments of the present invention, in a separation membrane cleaning system and a separation membrane cleaning method using the same, a chemical cleaning liquid is circulated in a same direction as that of a filtration direction in a dipping type separation membrane water treatment process, thereby increasing contact areas of the chemical with membrane pores and chemical cleaning efficiency.

### BRIEF DESCRIPTION OF THE DRAWINGS

The above and other aspects, features, and principles of the present invention will become apparent from the following detailed description of some exemplary embodiments in conjunction with the accompanying drawings, in which:

FIG. 1 is a diagram of a separation membrane cleaning system in accordance with an embodiment of the present invention;

FIG. 2 is a diagram of a process flow before a chemical cleaning liquid circulation stage in the separation membrane cleaning system of FIG. 1;

FIG. 3 is a diagram of a process flow of the chemical cleaning liquid circulation stage in the separation membrane cleaning system of FIG. 1;

FIG. 4 is a diagram of a process flow of a chemical cleaning liquid circulation stage in a separation membrane cleaning system in accordance with another embodiment of the present invention;

FIG. 5 is a diagram of a reverse washing process of a separation membrane cleaning system according to an embodiment of the present invention; and

FIG. 6 is a graph depicting chemical cleaning efficiency according to time, according to an embodiment of the present invention.

### DETAILED DESCRIPTION

Some exemplary embodiments of the present invention are described herein with reference to the accompanying drawings; however, embodiments of the present invention may be embodied in different forms and should not be construed as limited to the embodiments set forth herein. As those skilled in the art would realize, the described embodiments may be modified in various different ways, all without departing from the spirit or scope of the present invention. Accordingly, the drawings and description are to be regarded as illustrative in nature and not restrictive. Also, it should be noted that the drawings may not be to precise scale and some of the dimensions, such as width, length, thickness, and the like, may be exaggerated for clarity of description in the drawings. Also, although some elements are illustrated in the drawings, for convenience of description, other elements may be omitted but will be easily understood by those skilled in the art. It is to be understood that when an element is referred to as being “on” or “under” another element, for example, the element may be directly formed on or under the other element, or one or more intervening elements may also be present therebetween. Like components are denoted by like reference numerals throughout the drawings.

According to one or more embodiments of the present invention, a separation membrane cleaning system includes: a membrane filtration bath; a treated water storage bath storing some of treated water produced by the membrane filtration bath and discharging the treated water during reverse cleaning or chemical cleaning; and a chemical storage bath supplying a chemical during chemical cleaning of the membrane filtration bath, wherein the treated water produced by the membrane filtration bath is introduced into the treated water storage bath through a first pipe, the first pipe being provided with a fourth pipe transporting the chemical to the membrane filtration bath during reverse cleaning or chemical cleaning, the treated water storage bath is applied to reverse cleaning or chemical cleaning by discharging the treated water through a second pipe, and the chemical storage bath discharges the chemical through a third pipe, the third pipe being fluidically communicated with the fourth pipe to introduce the chemical into the membrane filtration bath.

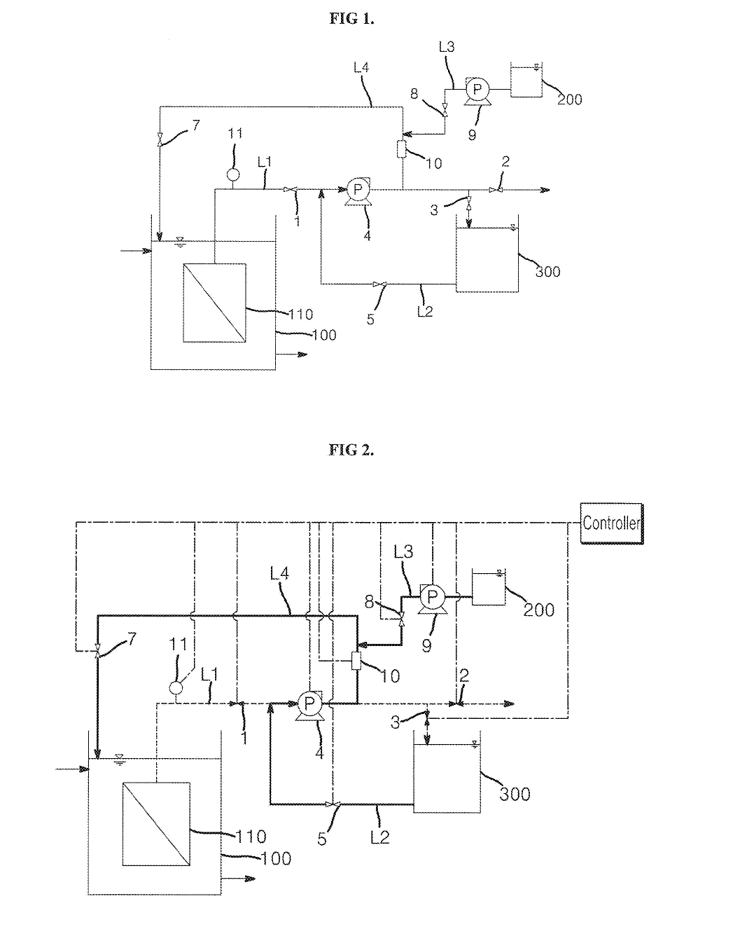

FIGS. 1 to 3 are schematic diagrams of a separation membrane cleaning system in accordance with an embodiment of the invention. Referring to FIGS. 1 to 3, the separation membrane cleaning system includes a membrane filtration bath 100, a chemical storage bath 200, and a treated water storage bath 300. The membrane filtration bath 100 is provided with a membrane module 110. The membrane module 110 may be a dipping type membrane module, which includes membranes dipped in the membrane filtration bath 100. Produced water filtered by the membrane module 110 in the membrane filtration bath 100 is fed to the treated water storage bath 300, which is connected to a water collection section of the membrane module 110 through a first pipe L1, by suction pressure of a produced water pump 4. The first pipe L1 is provided with a valve 1 before the produced water pump 4 and a valve 2 after the produced water pump 4.

The treated water storage bath 300 may store some of treated water produced by the membrane filtration bath 100 to discharge the treated water during reverse cleaning or chemical cleaning. When the treated water stored in the treated water storage bath 300 is used in chemical cleaning, a second pipe L2 for feeding the treated water may be used. The second pipe L2, which may be provided with a valve 5, is connected to the first pipe L1, and the treated water fed through the second pipe L2 is fed to a fourth pipe L4 by the produced water pump 4. The fourth pipe L4 extends from the first pipe L1 and is fludically communicated with a third pipe L3, which is connected to the chemical storage bath 200, and the treated water fed from the first pipe L1 and the chemical fed from the third pipe L3 are mixed to produce a chemical cleaning liquid, which in turn is introduced in-line to the membrane filtration bath 100 via the fourth pipe L4. According to an embodiment of the present invention, the produced water pump 4 may feed the produced water to the treated water storage bath 300, may feed the treated water for chemical cleaning, and may circulate the chemical cleaning liquid. The third pipe L3 may be provided with a chemical cleaning pump 9 and a valve 8 for discharging a chemical, and the fourth pipe L4 may be provided with a valve 7.

FIGS. 4 and 5 schematically show separation membrane cleaning systems in accordance with further embodiments of the present invention. In FIG. 4, the separation membrane cleaning system according to one embodiment may further include a separate circulation pump 14. The circulation pump 14 is separately provided to the cleaning system to circulate a chemical cleaning liquid at a low flow rate, since the membrane module 110 can suffer from significant increase in working burden due to high pressure when the chemical is circulated at a same or similar flow rate to that of water upon production by the produced water pump 4. The circulation pump 14, in one embodiment, may be operated at a flow rate of about ⅕ to 1 times that of the produced water pump 4. When the circulation pump 14 is separately provided, the circulation pump 14 may be placed on a fifth pipe L5, which is branched from the first pipe L1. The fifth pipe L5 may be connected again to the first pipe L1 for chemical cleaning circulation, or to the third pipe L3 or the fourth pipe L4 to be fluidically communicated with the first pipe L1. The fifth pipe L5 may be provided with a valve 12 before the circulation pump 14 and a valve 13 after the circulation pump 14.

Referring to FIG. 5, a separation membrane cleaning system according to another embodiment of the present invention may further include a sixth pipe L6 for reverse cleaning. The sixth pipe L6 may be branched from the first pipe L1 and may feed the treated water introduced from the treated water storage bath 300 by the produced water pump 4 to the water collection section of the membrane module 110.

The separation membrane cleaning system according to embodiments of the present invention may further include a pressure gauge 11 provided to the first pipe L1 connected to the membrane module 110 in the membrane filtration bath 100 to monitor chemical cleaning efficiency by measuring circulation flow rate and pressure, for measuring an inter-membrane differential pressure, and a controller.

A water purifying method and a reverse cleaning method by the separation membrane cleaning system according to an embodiment of the present invention are described further below. Herein, valves will be considered closed unless otherwise mentioned. Referring to FIG. 1, in one embodiment, when the valve 1 and the valve 3 are opened to allow raw water to be introduced into the membrane filtration bath 100, negative pressure is generated in the water collection section of the dipping type membrane module 110 by suction pressure of the produced water pump 4, and filtration is performed through membrane pores while passing from an outer side to an inner side of hollow fiber membranes potted in the membrane module 110. The filtered treated water is fed to the treated water storage bath 300 through the first pipe L1. Referring to FIG. 5, in one embodiment, reverse cleaning may be performed from an inner side to an outer side of the hollow fiber membranes after the treated water stored in the treated water storage bath 300 is introduced into the water collection section of the membrane module 110 sequentially via the second pipe L2, the first pipe L1, the sixth pipe L6, and the first pipe L1 again.

FIG. 1 shows a separation membrane cleaning method in accordance with an embodiment of the present invention. The method according to one or more embodiments of the present invention includes: storing some of treated water of the membrane filtration bath in the treated water storage bath while discharging remaining treated water outside; discharging the treated water stored in the treated water storage bath through the second pipe while discharging a chemical stored in a chemical storage bath through the third pipe, the second pipe and the third pipe being fluidically communicated with the fourth pipe such that the treated water and the chemical can be mixed to produce a chemical cleaning liquid; introducing the chemical cleaning liquid into the membrane filtration bath; filtering the chemical cleaning liquid through a membrane in the membrane filtration bath; and circulating the filtered chemical cleaning liquid.

FIG. 2 is a diagram of a process flow before the chemical cleaning liquid circulation stage in the method according to an embodiment of the present invention. Referring to FIG. 2, first, all concentrated water in the membrane filtration bath 100 is discharged. When the dipping type membrane separation membrane filtration bath 100 is evacuated, treated water collected in the treated water storage bath 300 is discharged to the fourth pipe L4 via the second pipe L2 and the first pipe L1 by opening the valve 5 and the valve 7 and operating the produced water pump 4. The chemical in the chemical storage bath 200 is introduced into the fourth pipe L4 via the third pipe L3 by opening the valve 8 and operating the chemical cleaning pump 9. The treated water and chemical introduced into the fourth pipe L4 are mixed with each other to produce a chemical cleaning liquid and are introduced in-line to the membrane filtration bath 100 via the fourth pipe L4.

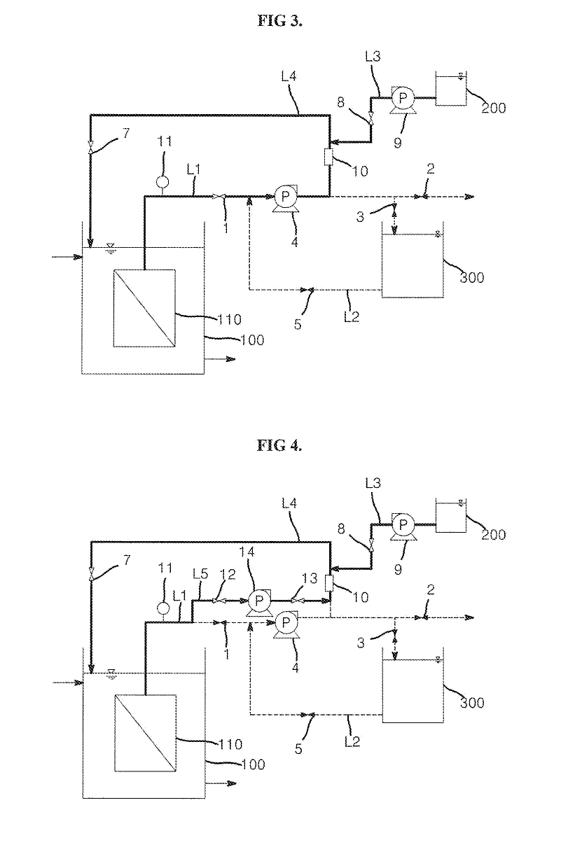

The circulation stage for the chemical cleaning liquid is described below with reference to FIG. 3. After the valve 1, the valve 7, and the valve 8 are opened, the produced water pump 4 is operated for circulation of the chemical cleaning liquid, and the valve 5 is closed. As the produced water pump 4 is operated, negative pressure is generated in the water collection section of the dipping type membrane module 110, and the chemical cleaning liquid in the membrane filtration bath 100 is introduced into the dipping type separation membrane module 110. The chemical cleaning liquid may be filtered through membrane pores while passing from an outer side to an inner side of the hollow fiber membranes, and the filtered chemical cleaning liquid may be introduced into the fourth pipe L4 via the first pipe L1 to be circulated. The filtered chemical cleaning liquid may be additionally mixed with the chemical discharged from the chemical storage bath 200 to be circulated.

A separation membrane cleaning method using a separation membrane cleaning system in accordance with another embodiment of the present invention is described below with reference to FIG. 4. The separation membrane cleaning system according to another embodiment of the present invention includes the separate circulation pump 14 for circulation of a chemical cleaning liquid, instead of the produced water pump 4. In the separation membrane cleaning method using this system, the step of discharging concentrated water from the membrane filtration bath 100; the step of mixing treated water from the treated water storage bath 300 and a chemical from the chemical storage bath 200; and the step of introducing the chemical cleaning liquid into the membrane filtration bath 100 may be the same as those in the separation membrane cleaning method using the separation membrane cleaning system described above with reference to FIGS. 1 to 3, except for the step of circulating the chemical cleaning liquid. Referring to FIG. 4, in the step of circulating the chemical cleaning liquid using the separation membrane cleaning system according to the embodiment shown in FIG. 4, after the valve 7, the valve 8, the valve 12, and the valve 13 are opened, the circulation pump 14 is operated to circulate the chemical cleaning liquid. As the circulation pump 14 is operated, negative pressure is generated in the water collection section of the dipping type membrane module 110, and the chemical cleaning liquid collected by the membrane filtration bath 100 is introduced into the membrane module 110. The chemical cleaning liquid is filtered through membrane pores while passing from an outer side to an inner side of the hollow fiber membranes, and the filtered chemical cleaning liquid may be introduced into the fourth pipe L4 via the first pipe L1 and the fifth pipe L5 for circulation. The filtered chemical cleaning liquid may be additionally mixed with the chemical discharged from the chemical storage bath 200 to be circulated.

As described above, the separation membrane cleaning system according to embodiments of the present invention may further include the pressure gauge 11 for measuring circulation flow rate and pressure to monitor a chemical cleaning efficiency; a mass flow meter 10 for measuring a circulation flow rate; and a controller.

The controller measures a water penetration degree and calculates a recovery rate to anticipate and control a recovery degree of contaminated membranes, that is, chemical cleaning efficiency, based on the calculated recovery rate. First, when the chemical cleaning liquid filtered by the membrane filtration bath is circulated, penetration flow rate and pressure (differential pressure between membranes) are measured to measure the water penetration degree. When the recovery rate is calculated based on the water penetration degree, chemical cleaning efficiency may be anticipated based on the recovery rate.

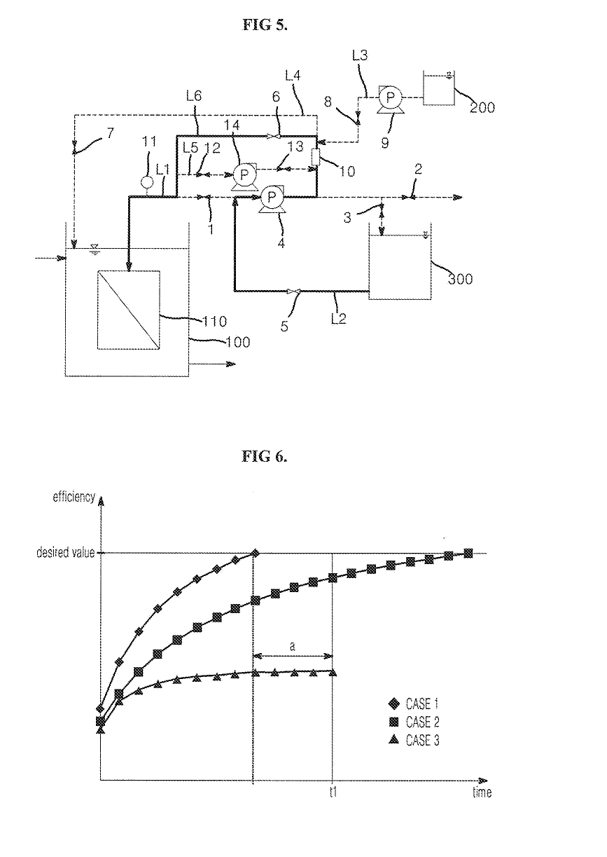

FIG. 6 is a graph depicting a relationship between chemical cleaning time and chemical cleaning efficiency, for illustrating chemical cleaning efficiency of embodiments of the present invention. Referring to FIG. 6, chemical cleaning efficiency is monitored before a chemical cleaning time t1 (e.g., a predetermined chemical cleaning time) by measuring a penetration flow rate and a pressure and calculating a water penetration degree of membranes and a recovery rate during circulation of a chemical cleaning liquid. If the monitored chemical cleaning efficiency is sufficient (i.e. a desired chemical cleaning efficiency is obtained) before the chemical cleaning time t1 (CASE 1), cleaning is immediately finished at a time t2 to minimize or reduce the chemical cleaning time and minimize reduction in life span of the separation membranes according to contact of the chemical, and energy consumption can be minimized or reduced by intermittent bubbling and circulation of the chemical during chemical cleaning. In another example, when the monitored chemical cleaning efficiency is not sufficient at the chemical cleaning time t1 (CASE 2), circulation of the chemical is continued without stopping chemical cleaning until the desired chemical cleaning efficiency is obtained, whereby cleaning time and chemical usage can be reduced by increasing chemical cleaning efficiency. In a further example, when it is impossible to secure the desired chemical cleaning efficiency through extension of time with a current chemical in consideration of the monitored cleaning efficiency (CASE 3), other chemical cleaning conditions such as another type of chemical, change in temperature of the chemical, and the like, may be prepared (e.g., immediately prepared) to reduce a time period (time period “a”) providing weak cleaning effects, thereby minimizing or reducing chemical cleaning time and energy consumption.

In the separation membrane cleaning method according to the present invention, a chemical cleaning liquid is circulated in a same direction as the filtering direction to form flow of the chemical cleaning liquid into the membrane pores, whereby chemical cleaning efficiency can be increased by increasing contact between the membrane pores and the chemical, as compared with a cleaning method wherein the membranes are dipped in the chemical cleaning liquid. Further, although chemical cleaning efficiency is determined by measuring the water penetration degree of the membranes after completion of chemical cleaning in a typical chemical cleaning method, according to embodiments of the present invention, chemical cleaning efficiency can be identified in the chemical cleaning/circulation stage by monitoring chemical cleaning efficiency during circulation of the chemical cleaning liquid. Thus, chemical cleaning can be immediately controlled.

Although some embodiments of the present invention have been described herein, the present invention is not limited to these embodiments and can be realized in various ways. Further, it should be understood by those skilled in the art that various modifications, variations, and alterations can be made without departing from the spirit and scope of the present invention. Accordingly, these embodiments are given by way of illustration only, and should not be construed in any way as limiting the present invention.

What is claimed is:

1. A separation membrane cleaning system comprising:
a membrane filtration bath;
a treated water storage bath configured to store treated water produced by the membrane filtration bath and discharge the treated water during reverse cleaning or chemical cleaning;
a chemical storage bath configured to supply a chemical during chemical cleaning of the membrane filtration bath;
a first pipe fluidically communicated between the membrane filtration bath and the treated water storage bath to transport the treated water produced by the membrane filtration bath to the treated water storage bath, and a fourth pipe fluidically communicated with the first pipe to transport the chemical to the membrane filtration bath;
a second pipe to transport the treated water from the treated water storage bath during reverse cleaning or chemical cleaning; and
a third pipe fluidically communicated with the fourth pipe to transport the chemical from the chemical storage bath and allow a chemical cleaning liquid formed by mixing the chemical and the treated water to be introduced into the membrane filtration bath.

2. The separation membrane cleaning system according to claim 1, wherein the second pipe is connected to the first pipe and fluidically communicated therewith.

3. The separation membrane cleaning system according to claim 1, further comprising a produced water pump on the first pipe.

4. The separation membrane cleaning system according to claim 1, further comprising a controller configured to control production of the treated water in the membrane filtration bath, supply of the chemical in the chemical storage bath, and discharge of the treated water from the treated water storage bath.

5. The separation membrane cleaning system according to claim 1, further comprising:
a fifth pipe branched form the first pipe and fluidically communicated with the fourth pipe; and
a circulation pump on the fifth pipe.

6. The separation membrane cleaning system according to claim 5, further comprising:
a controller configured to control production of the treated water in the membrane filtration bath, supply of the chemical in the chemical storage bath, and discharge of the treated water from the treated water storage bath,
wherein at least one of the first to fifth pipes is provided with a cut-off valve to be opened or closed by the controller.

7. The separation membrane cleaning system according to claim 5, wherein the chemical is circulated through the first pipe, the fifth pipe, and the fourth pipe, and a water penetration degree of membranes and a chemical cleaning efficiency are calculated by measuring a circulation flow rate and a pressure.

8. The separation membrane cleaning system according to claim 1, further comprising:
a controller configured to control production of the treated water in the membrane filtration bath, supply of the chemical in the chemical storage bath, and discharge of the treated water from the treated water storage bath; and
a pressure gauge provided to the first pipe,
wherein information of the pressure gauge is transmitted to the controller.

9. The separation membrane cleaning system according to claim 8, further comprising:
a mass flow meter provided to the fourth pipe,
wherein information of the mass flow meter is transmitted to the controller.

10. The separation membrane cleaning system according to claim 1, wherein the treated water produced by the membrane filtration bath is discharged outside or fed to the treated water storage bath through the first pipe during filtration, and the chemical is injected into the fourth pipe through the third pipe while the treated water is fed to the membrane filtration bath through the second pipe and the fourth pipe during chemical cleaning.

11. The separation membrane cleaning system according to claim 1, wherein the chemical cleaning liquid is circulated through the first pipe and the fourth pipe, and a water penetration degree of membranes and a chemical cleaning efficiency are calculated by measuring a circulation flow rate and a pressure.

12. A separation membrane cleaning method using the separation membrane cleaning system according to claim 1, the method comprising:
storing some of the treated water produced by the membrane filtration bath in the treated water storage bath, and discharging a remainder of the treated water outside;
discharging the treated water stored in the treated water storage bath through the second pipe while discharging the chemical stored in the chemical storage bath through the third pipe, the second pipe and the third pipe being fluidically communicated with the fourth pipe such that the treated water and the chemical are mixed to produce the chemical cleaning liquid;
introducing the chemical cleaning liquid into the membrane filtration bath;
filtering the chemical cleaning liquid through membranes in the membrane filtration bath; and
circulating the filtered chemical cleaning liquid.

13. The separation membrane cleaning method according to claim 12, wherein the filtered chemical cleaning liquid is circulated by a produced water pump.

14. The separation membrane cleaning method according to claim 13, wherein the produced water pump is on the first pipe.

15. The separation membrane cleaning method according to claim 12, wherein the filtered chemical cleaning liquid is circulated by a circulation pump.

16. The separation membrane cleaning method according to claim 15, wherein the circulation pump is on a fifth pipe branched from the first pipe and fluidically communicated with the fourth pipe.

17. The separation membrane cleaning method according to claim 12, further comprising measuring a circulation flow rate and a pressure while monitoring a chemical cleaning efficiency to control chemical cleaning.
